(19) United States
(12) Patent Application Publication
(10) Pub. No.: US 2014/0201394 A1
(43) Pub. Date: Jul. 17, 2014

(54) Device Driver Detection and Management System

(71) Applicant: David L. Wagstaff, Lake Forest, CA (US)

(72) Inventor: David L. Wagstaff, Lake Forest, CA (US)

(73) Assignee: Lantronix, Inc., Irvine, CA (US)

(21) Appl. No.: 14/157,976

(22) Filed: Jan. 17, 2014

Related U.S. Application Data
(60) Provisional application No. 61/753,696, filed on Jan. 17, 2013.

(51) Int. Cl. G06F 9/44; G06F 13/10

(52) U.S. Cl. CPC G06F 9/4415; G06F 13/102
USPC 710/8

(57) ABSTRACT

Apparatus, systems and methods in which one can implement a legacy device management system to control and operate a legacy device coupled to the system. The system is configured to pull device attributes from the legacy device and use those attributes to obtain an inventory of possible device drivers that could be used with the legacy device. The system then applies acquisition rules to whittle down and prioritize the possible device drivers within a matrix and then identifies which driver to use in accordance with the system's local configuration. The system is generally implemented in a stand-alone apparatus that could be coupled between the legacy device and a computer system.

### CROSS REFERENCE TO RELATED APPLICATION

The present application claims priority to the earlier filed U.S. Provisional Patent Application No. 61/753,696 filed on Jan. 17, 2013.

### FIELD OF THE INVENTION

The field of the invention is systems and methods for detecting and managing device drivers.

### BACKGROUND

The present invention is generally related to devices and systems that detect, select and manage device drivers, and more particularly to devices and systems that organize and select device drivers based on the known attributes of the device and its local configuration.

Others have put forth efforts towards developing systems and methods that select appropriate device drivers to control devices coupled to a computer system. For example, U.S. Pat. No. 6,785,894 to Ruberg uses a remote device driver that is configured to emulate a number of different device drivers that could be connected to the computer system. However, Ruberg requires a system administrator to manually identify and configure the remote device driver for emulation. Some system administrators, however, may not know how to correctly identify the device or the appropriate device driver to be associated with the device, causing Ruberg's remote device driver to be configured incorrectly.

U.S. patent no. 2009/0100422 to Abe teaches a computer system that automatically installs device drivers in a computer system based upon a matrix that designates which device drivers should be installed upon designated computers. Abe's computer system, however, requires a system administrator to pre-populate each computer system with a matrix that designates which devices should be installed upon each computer. Without such the pre-populated matrix, Abe's system would be unable to select device drivers that need to be installed upon each computer.

U.S. patent no. 2012/233356 to Nishio teaches a computer system that automatically installs device drivers of devices coupled to the computer system based upon a driver path list that associates device numbers with drivers saved on the computer system. When Nishio's computer system queries devices coupled to the computer system, the devices return a device number which Nishio's computer system then cross-references against the driver path list in order to determine which driver should be installed on the computer system. Nishio's computer system, however, only associates a single driver with each device identifier. Nishio fails to take into account that a single device may have a plurality of drivers that could be installed to utilize the device on the computer system.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Even though the above references are useful for their intended purposes, they do not address circumstances where a plurality of device drivers are compatible with a legacy device coupled to the computer system, but only one device driver can be selected to be installed in the computer system. In such circumstances, it would be beneficial to have a system that could automatically determine which driver, out of a plurality of drivers, should be installed to control a legacy device. Thus, there is still a need for an improved device management system for controlling legacy devices coupled to a computer system.

### SUMMARY OF THE INVENTION

The present inventive subject matter provides apparatus, systems and methods in which one can acquire and manage device drivers according to given acquisition rules for legacy devices.

To this end, in a exemplary embodiment of the present invention, a legacy device management system comprising: a legacy device interface configured to acquire legacy device attributes from an external legacy device; a memory storing driver acquisition rules and a local configuration, wherein the driver acquisition rules govern driver management; a legacy device management module coupled with the memory and the legacy device interface; and a driver rules engine coupled with the legacy device interface and memory, wherein the driver rules engine is configured to: construct a driver request targeting a driver database based on the legacy device attributes; submit the driver request to an external driver database over a network; receive a driver list from the external driver database satisfying the driver request; generate an optimized driver matrix from the driver list according to the driver acquisition rules; identify at least one driver from the driver matrix based on the local configuration; and configure the legacy device management module to exchange management data with the legacy device via the legacy device interface according to the at least one driver.

In another exemplary embodiment, wherein the memory lacks sufficient capacity to store the external driver database.

In another exemplary embodiment, wherein the legacy device interface is configured to query the legacy device and receive the legacy device attributes in response to the query.

In another exemplary embodiment, wherein the query comprises a discovery query.

In another exemplary embodiment, wherein the discovery query comprises at least one of a broadcast message, a unicast message, an anycast message, and a multicast message.

In another exemplary embodiment, wherein the legacy device interface is configured to receive the legacy device attributes as a pushed message from the legacy device.

In another exemplary embodiment, wherein the driver acquisition rules comprise user-defined driver acquisition criteria.

In another exemplary embodiment, wherein the user-defined driver acquisition criteria comprises a criterion based on at least one of the following: a cost, a distance, an ink level, a print quality, a speed, an ink cost, a paper cost, a media size, a finishing capability, a color capability, an authorization, an authentication, an account, an audit, a proximity, a network connection, and a topology.

In another exemplary embodiment, wherein the criteria comprises a requirement criterion.

In another exemplary embodiment, wherein the criteria comprises a conditional criterion.

In another exemplary embodiment, further comprising the external driver database.

In another exemplary embodiment, wherein the external driver database is configured to store a plurality of driver objects, each driver object comprising driver attributes.

In another exemplary embodiment, wherein the external driver database is configured to store the driver objects according to a schema adheres to a legacy device attribute space.

In another exemplary embodiment, wherein the driver request adheres to the legacy device attribute space.

In another exemplary embodiment, wherein the external driver database comprises a network service.

In another exemplary embodiment, wherein the network service comprises at least one of the following: platform as a service, infrastructure as a service, and software as a service.

In another exemplary embodiment, wherein the external driver database comprises a local network driver server.

In another exemplary embodiment, wherein the matrix is ordered according to at least one metric derived as a function of the legacy device attributes.

In another exemplary embodiment, comprising an apparatus comprise the legacy device interface, the memory, the management module, and the rules engine.

In another exemplary embodiment, wherein the apparatus comprise a print server.

In another exemplary embodiment, wherein the apparatus comprise a device server.

In another exemplary embodiment, wherein the apparatus comprises an embedded device server.

In another exemplary embodiment, wherein the apparatus comprise an analog device server.

In another exemplary embodiment, wherein the apparatus comprise a medical device gateway.

In another exemplary embodiment, wherein the apparatus comprise a console server.

In another exemplary embodiment, wherein the apparatus comprise a KVM device.

In another exemplary embodiment, wherein the apparatus comprise a programmable logic controller.

In another exemplary embodiment, wherein the apparatus comprise an access controller.

In another exemplary embodiment, wherein the apparatus comprise a metering server.

In another exemplary embodiment, wherein the legacy device interface comprises a wireless interface.

Among the many different possibilities contemplated, one embodiment of the inventive subject matter is a legacy device management system comprising a legacy device interface, a memory, a legacy device management module and a driver rules engine. Legacy devices are devices designed to be used with older computer systems and are generally not plug and play compatible, possibly requiring user intervention during the installation process, such as a setting of physical jumpers or a designation of computer system resources for the legacy device. Exemplary legacy devices include printers, storage devices, medical instruments, scanners, tape readers/writers, sensors, and other computer-controlled machinery.

Additionally, in an exemplary embodiment, the legacy device interface generally configured to acquire device attributes from an external device functionally coupled to the device interface, for example through a port or a wireless connector. Such device attributes could include, for example, a location of the device, a device make, a device model, and a device unique identifier. The device interface could acquire the device attributes through a query sent to the device, wherein the device is configured to respond to the query by sending attributes associated with the device. Such a query could be device-specific, or could follow a generic protocol associated with a plurality of devices that could be coupled to the device interface, such as a generic discovery query sent out to all devices coupled to the device interface. The device discovery query could be a broadcast message, a unicast message, an anycast message, or a multicast message without departing from the scope of the invention. In other embodiments, the device interface is configured to receive pushed messages from the device, such as a periodic broadcast or a ping sent from the device.

The memory generally stores driver acquisition rules that govern management of drivers that control devices coupled to the device interface. The driver acquisition rules could be defined by a common protocol or standard, or could have acquisition criteria that are user-defined. The acquisition criteria could include, for example, a cost of the device, a distance of the device, an ink level of the device (where the device is a printing apparatus), a print quality of the device, a speed of the device, a cost of consumables of the device (such as ink, paper, food, drink, or machine parts as part of an assembly line, a finishing capability of the device, a color capability of the device, an authorization for using the device, an authentication as part of a security protocol for the device, an account, an audit, a proximity to the legacy device, a network connection, or a topology. In some cases the acquisition criteria could be designated as a set of requirement criterion that must be met before the device is installed (or discovered) or as a set of conditional criterion that may be met before the device is installed (or discovered). Meeting conditional criterion could trigger additional or optional installation options that are only present when the possible criterion are met.

In another exemplary embodiment, while the memory could be configured to store the driver database, in some embodiments, the memory lacks sufficient capacity to store all drivers that could possibly be coupled to the device interface. In such embodiments, the driver database is frequently external to the legacy device management system, and could comprise several database systems accessible by the legacy device management system. In either case, the driver database could be configured to store many different driver objects, where each driver object holds attributes of one or more drivers. The driver database could also be configured to normalize driver objects across a pre-defined legacy device attribute space. Using a common attribute space to hold information on many different driver objects ensures that a common database holds driver objects that have differing attributes.

In another exemplary embodiment, the driver database could also include a network service that is provided to the legacy device management system, such as a platform as a service, an infrastructure as a service, or a software as a service. In other embodiments, the driver database could include a local network driver server as well.

A further exemplary embodiment, the driver rules engine is generally functionally coupled to the device interface, memory, and the driver database (whether the driver database is configured to reside within the memory, external to the memory, or even external to the legacy device management system). Through such coupling, the driver rules engine could use the device attributes received from the device interface to construct a driver request to the driver database. The driver request could then be submitted to the driver database, for example over a network functionally coupling the driver rules engine to the driver database, and could then receive a list of drivers from the external driver database that satisfies the driver request. In some embodiments, the driver request adheres to the legacy device attribute space utilized in the driver database. The driver rules engine could then use the driver acquisition rules stored in memory to pare down and/or organize the list of drivers into an optimized driver matrix that prioritizes certain drivers within the driver list over others.

In another exemplary embodiment, the driver rules engine could be configured to automatically select a driver from the driver matrix based upon the local configuration of the legacy device management system, or could be configured to prompt a user for selecting a driver from the optimized driver matrix to identify which driver should be used to control the device. The local configuration is generally created from the polled device attributes and could be stored within the memory. The resulting matrix of device drivers could be organized in a variety of ways, for example as a function of the legacy device attributes, as a function of user-defined preferences, or as a function of both. Once a driver has been selected, the driver rules engine could then install the driver in the memory and configure a legacy device management module (functionally coupled to the memory and the legacy device interface) to exchange management data with the legacy device via the legacy device interface using the driver.

In another exemplary embodiment, the legacy device management system is preferably implemented as a stand-alone apparatus that could be coupled to a computer system to help the computer system manage the legacy device. The apparatus could be, for example, a print server, a device server, an embedded device server, an analog device server, a medical device gateway, a console server, a KVM device, a programmable logic controller, an access controller, or a metering server. In such an embodiment, the apparatus could be physically coupled to a legacy device, allowing any computer functionally coupled to the apparatus to access, manage, and otherwise control the legacy device.

In yet another exemplary embodiment of the present invention, after the legacy device management system has properly installed and configured a driver to control the legacy device, the system could then manage the legacy device in a variety of ways using the driver. For example, the system could automatically provision variables for the device or could prompt a user to do so, such as defining a name of the device or defining which computer systems have access to the device. The system could also monitor consumables used by the legacy device, such as ink levels, paper levels, color levels, etc. (MILLARS). At the very least, the system generally allows any computer system functionally coupled to the legacy device management system to control, operate, and communicate with the legacy device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a general schematic of a device driver detection and management system.

FIG. 2 provides examples of device driver matrixes optimized according to various driver acquisition rule sets.

### DETAILED DESCRIPTION

It should be noted that while the following description is drawn to a computer/server based driver detection and management system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including the detection of device drivers, the selection of device drivers based on a governing rule set and the subsequent management of data exchange according to the selected device drivers.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

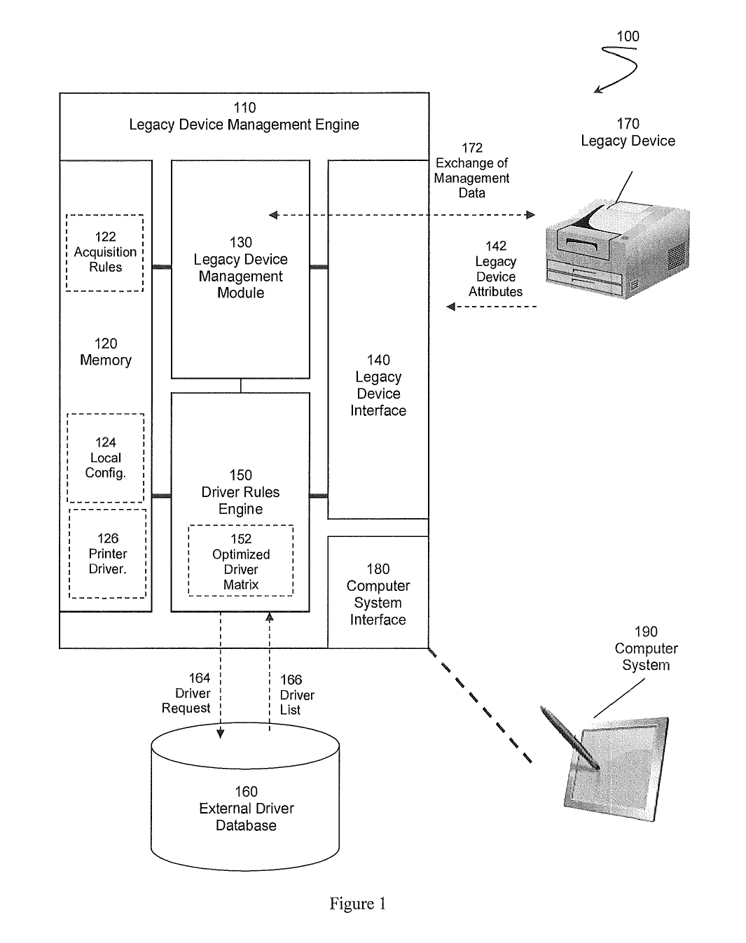

In FIG. 1, a legacy device management system 100 is presented in which a legacy device management engine 110 exchanges data with one or more external legacy devices 170. The legacy device management engine 110 could comprise a memory 120, a legacy device management module 130, a legacy device interface 140, and a driver rules engine 150. The legacy device management engine 110 could be coupled to computer system 190, shown here euphemistically as a tablet computer wirelessly coupled to legacy device management engine 110 through computer system interface 180.

The legacy device interface 140 is configured to acquire legacy device attributes 142 from the one or more legacy devices 170 in order to determine the local configuration of the system. The legacy device interface 140 may be configured to query the legacy device 170 and receive the legacy device attributes 142 in response to the query. This query could comprise a discovery query, wherein the discovery query could comprise at least one of a broadcast message, a unicast message, an anycast message, or a multicast message. Alternatively, the legacy device interface 140 could be configured to receive the legacy device attributes 142 as a pushed message from the external legacy device 170. The legacy device interface 140 can be either a wired or wireless interface.

Memory 120 is configured to store driver acquisition rules 122 and the local configuration 104, which is generally created as a function of device attributes 142. In many embodiments, the memory 120 lacks sufficient capacity to store a large database of actual device drivers. Instead, device drivers are acquired, according to the driver acquisition rules 122 and the device attributes 142, from an external driver database 160.

The driver rules engine 150 is coupled to both the legacy device interface 140 and the memory 120 and is configured to construct a driver request 164 based on the acquired legacy device attributes 142. The driver rules engine 150 could then submit the driver request 164 to the external driver database 160 and then receive, a driver list 166, from the external driver database 160, satisfying the driver request 164. Driver list 166 generally includes all possible drivers that are compatible with legacy device 170.

Once the driver list 166 is received, driver rules engine 150 could generate an optimized driver matrix 152 from the driver list 166 according to the stored driver acquisition rules 122. The driver matrix 152 could be ordered according to at least one metric derived as a function of the legacy device attributes 142. From the optimized driver matrix 152, the driver engine could then automatically identify at least one driver based on the stored local configuration 124. For example, the local configuration could have a printer with a driver that works for Windows® operating systems, a driver that works for IOS® operating systems, and Android® operating systems, and is functionally coupled to an iPad® computer system, influencing the legacy device management system to install an iPad® printer driver 126 to memory 120. In alternative embodiments, the driver matrix 152 could be presented to a user interface of computer system 190, allowing an administrative user to select a driver from the optimized driver matrix 152.

Once the printer driver 126 has been installed into memory 120, the driver rules engine 150 could configure the legacy device management module 130 to exchange management data with the external legacy device 170 via the legacy device interface 140 according to the at least one identified driver. In this system and related methods, driver detection, selection and management are generally governed by the stored driver acquisition rules 122 and local configuration 124.

In most embodiments, the stored driver acquisition rules 122 comprise user-defined acquisition criteria. Such user acquisition criteria could include at least one of a cost, a distance, an ink level, a print quality, a speed, an ink cost, a paper cost, a media size, a finishing capability, a color capability, an authorization, an authentication, an account, an audit, a proximity, a network connection, or a topology. Additionally, the user-defined acquisition criteria could comprise at least one of a requirement criterion or a conditional criterion.

In preferred embodiments, the external driver database 160 comprises a network service. In such instances, the network service could comprise at least one of a platform as a service, infrastructure as a service or software as a service. Additionally, the external driver database 160 could comprise a local network driver server.

The system described above could be incorporated into an apparatus comprising the legacy device interface 140, the memory 120, the legacy device management module 130 and the driver rules engine 150. This apparatus could comprise any one of a printer server, a device server, an embedded device server, an analog device server, a medical device gateway, a console server, a KVM device, a programmable logic controller, an access controller, or a metering service.

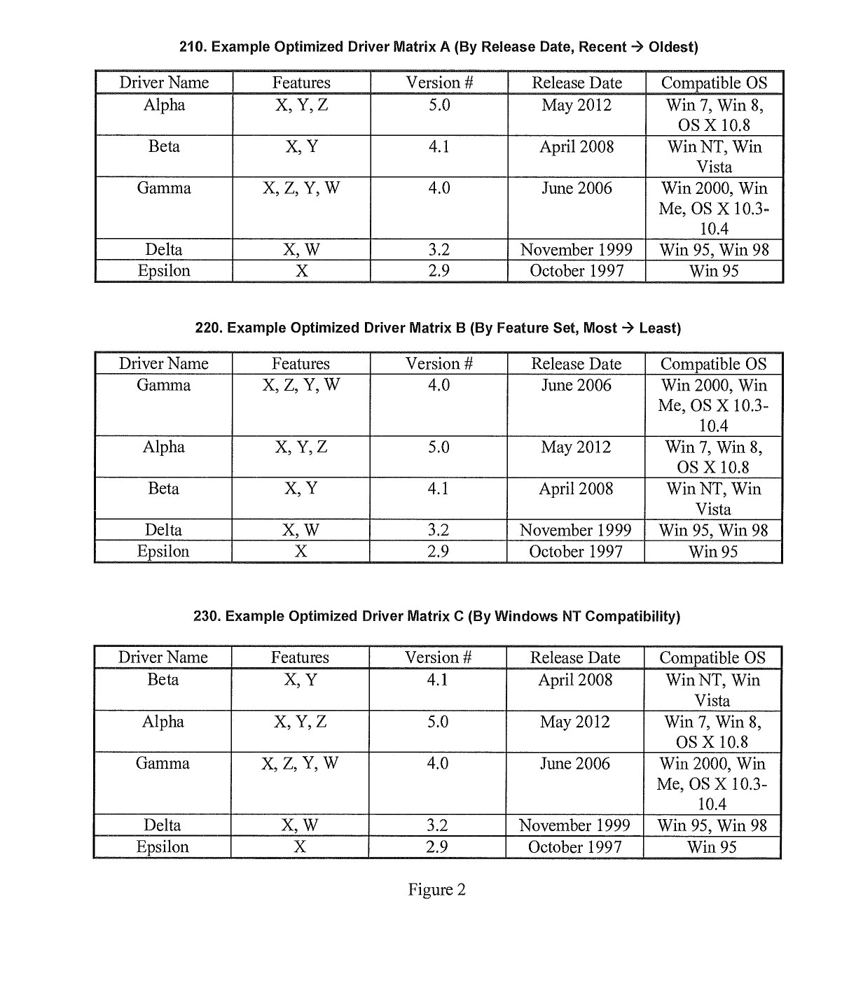

FIG. 2 provides three exemplary optimized driver matrices 152 that could be generated by the driver rules engine 150 according to the driver acquisition rules 122 and further ordered according to the legacy device attributes 142. Each example consists of a matrix of five device drivers derived from the driver list 166 provided by the external driver database 160. The matrix is then populated with values for several device driver attributes, including driver features, version numbers, release dates and operating system compatibility. The three examples demonstrate different orderings of the matrix according to data acquisition rules and the local configuration. Example 210 orders the device drivers by release date or version number. Generally, the matrices prioritizes the drivers located closer to the top of the list over drivers located lower on the list to help identify the driver to be installed based upon the local configuration.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A legacy device management system comprising:
a legacy device interface configured to acquire legacy device attributes from an external legacy device;
a memory storing driver acquisition rules and a local configuration, wherein the driver acquisition rules govern driver management;
a legacy device management module coupled with the memory and the legacy device interface; and
a driver rules engine coupled with the legacy device interface and memory, wherein the driver rules engine is configured to:
construct a driver request targeting a driver database based on the legacy device attributes;
submit the driver request to an external driver database over a network;
receive a driver list from the external driver database satisfying the driver request;
generate an optimized driver matrix from the driver list according to the driver acquisition rules;
identify at least one driver from the driver matrix based on the local configuration; and
configure the legacy device management module to exchange management data with the legacy device via the legacy device interface according to the at least one driver.

2. The system of claim 1, wherein the memory lacks sufficient capacity to store the external driver database.

3. The system of claim 1, wherein the legacy device interface is configured to query the legacy device and receive the legacy device attributes in response to the query.

4. The system of claim 3, wherein the query comprises a discovery query.

5. The system of claim 4, wherein the discovery query comprises at least one of a broadcast message, a unicast message, an anycast message, and a multicast message.

6. The system of claim 1, wherein the legacy device interface is configured to receive the legacy device attributes as a pushed message from the legacy device.

7. The system of claim 1, wherein the driver acquisition rules comprise user-defined driver acquisition criteria.

8. The system of claim 7, wherein the user-defined driver acquisition criteria comprises a criterion based on at least one of the following: a cost, a distance, an ink level, a print quality, a speed, an ink cost, a paper cost, a media size, a finishing capability, a color capability, an authorization, an authentication, an account, an audit, a proximity, a network connection, and a topology.

9. The system of claim 7, wherein the criteria comprises a requirement criterion.

10. The system of claim 7, wherein the criteria comprises a conditional criterion.

11. The system of claim 1, further comprising the external driver database.

12. The system of claim 11, wherein the external driver database is configured to store a plurality of driver objects, each driver object comprising driver attributes.

13. The system of claim 11, wherein the external driver database is configured to store the driver objects according to a schema adheres to a legacy device attribute space.

14. The system of claim 13, wherein the driver request adheres to the legacy device attribute space.

15. The system of claim 11, wherein the external driver database comprises a network service.

16. The system of claim 15, wherein the network service comprises at least one of the following:
platform as a service, infrastructure as a service, and software as a service.

17. The system of claim 11, wherein the external driver database comprises a local network driver server.

18. The system of claim 1, wherein the matrix is ordered according to at least one metric derived as a function of the legacy device attributes.

19. The system of claim 1, comprising an apparatus comprise the legacy device interface, the memory, the management module, and the rules engine.

20. The system of claim 19, wherein the apparatus comprise a print server.

21. The system of claim 19, wherein the apparatus comprise a device server.

22. The system of claim 19, wherein the apparatus comprises an embedded device server.

23. The system of claim 19, wherein the apparatus comprise an analog device server.

24. The system of claim 19, wherein the apparatus comprise a medical device gateway.

25. The system of claim 19, wherein the apparatus comprise a console server.

26. The system of claim 19, wherein the apparatus comprise a KVM device.

27. The system of claim 19, wherein the apparatus comprise a programmable logic controller.

28. The system of claim 19, wherein the apparatus comprise an access controller.

29. The system of claim 19, wherein the apparatus comprise a metering server.

30. The system of claim 1, wherein the legacy device interface comprises a wireless interface.
